(19) United States
(12) Patent Application Publication
(10) Pub. No.: US 2025/0385315 A1
(43) Pub. Date: Dec. 18, 2025

(54) ELECTROLYTE FOR USE IN SECONDARY LITHIUM BATTERIES WITH NICKEL-RICH CATHODE MATERIALS

(71) Applicant: Battelle Memorial Institute, Richland, WA (US)

(72) Inventors: Jie Xiao, Richland, WA (US); Bingbin Wu, Richland, WA (US); Dianying Liu, Richland, WA (US); Jing Wu, Richland, WA (US)

(21) Appl. No.: 18/741,094

(22) Filed: Jun. 12, 2024

(51) Int. Cl. H01M 10/0568; H01M 4/02; H01M 4/36; H01M 4/505; H01M 4/583; H01M 10/0567; H01M 10/0569

(52) U.S. Cl. CPC H01M 10/0568; H01M 4/366; H01M 4/505; H01M 4/583; H01M 10/0567; H01M 10/0569; H01M 2004/027; H01M 2004/028; H01M 2300/0034; H01M 2300/0037

(57) ABSTRACT

An electrolyte for use in a secondary lithium battery having a nickel-rich cathode material includes lithium bis(fluorosulfonyl)imide, a solvent system including a first solvent and a fluorinated cyclic ether having a molecular weight greater than 110 g/mol, and, optionally, an additive. The first solvent may be a carbonate, an ester, an ether, a fluorinated carbonate, a fluorinated ester, a fluorinated ether, or any combination thereof. The solvent system comprises at least 50 wt % of the fluorinated cyclic ether.

### ACKNOWLEDGMENT OF GOVERNMENT SUPPORT

This invention was made with Government support under Contract DE-AC05-76RL01830 awarded by the U.S. Department of Energy. The Government has certain rights in the invention.

### FIELD

This disclosure concerns aspects of an electrolyte for use in secondary lithium batteries with nickel (Ni)-rich cathode materials.

### SUMMARY

Aspects of an electrolyte for use in secondary lithium batteries comprising a nickel-rich cathode material are disclosed, along with aspects of secondary lithium batteries including the electrolyte. The disclosed electrolytes include lithium bis(fluorosulfonyl)imide (LiFSI), and a solvent system comprising a first solvent and a fluorinated cyclic ether having a molecular weight greater than 110 g/mol (hereinafter referred to as the “fluorinated cyclic ether). Optionally, the electrolyte may further include an additive.

In some aspects, the first solvent comprises a carbonate, an ester, an ether, a fluorinated carbonate, a fluorinated ester, a fluorinated ether, or any combination thereof. In some aspects, the fluorinated cyclic ether does not comprise a component of the first solvent, and the solvent system comprises at least 50 wt % of the fluorinated cyclic ether. If the solvent system comprises a combination of a non-fluorinated acyclic ether and a fluorinated acyclic ether having a fluorination ratio≥60%, then a molar ratio of the non-fluorinated acyclic ether to the fluorinated cyclic ether is not within a range of 0.25-3 or a molar ratio of the fluorinated acyclic ether to the fluorinated cyclic ether is not within a range of 0.5-6. In certain implementations, the solvent system comprises at least 60 wt % or at least 70 wt % of the fluorinated cyclic ether.

In any of the foregoing or following aspects, the electrolyte may include x moles LiFSI, y moles of the first solvent, and z moles of the fluorinated cyclic ether, where a molar ratio of x:y:z is 1:0.05-10:0:05-10. In some implementations, the molar ratio of x:y:z is 1:0.5-5:2-8.

In any of the foregoing or following aspects, the first solvent may include dimethoxyethane (DME), 1-methoxy-2-(trifluoromethoxy) ethane (MTE), dimethyl carbonate (DMC), ethyl propionate (EP), or any combination of two or more thereof. In any of the foregoing or following aspects, the fluorinated cyclic ether may include a 5-membered ring or a 6-membered ring. In some aspects, the fluorinated cyclic ether is a fluorinated tetrahydrofuran.

In any of the foregoing or following aspects, the electrolyte may comprise an additive. In some implementations, the additive is (i) vinylene carbonate (VC), (ii) ethylene carbonate (EC), (iii) fluoroethylene carbonate (FEC), (iv) vinyl ethylene carbonate (VEC), (v) LiPO₂F₂, (vi) lithium bis(oxalato)borate (LiBOB), (vii) lithium difluoro(oxalato)borate (LiDFOB), (viii) lithium difluorobis(oxalato)phosphate (LiDFOP), (ix) LiNO₃, (x) tris(2,2,2-trifluoroethyl) phosphite (TFPi), (xi) ethylene sulfite (ES), (xii) 1,3-propylene sulfite (1,3-PS), (xiii) 1,3,2-dioxathiane-2,2-dioxide (DTD), (xiv) methylene methanedisulfonate (MMDS), or (xv) any combination of at least two of (i) to (xiv). In some implementations, each additive independently is present in an amount of not more than 5 wt % or an amount of not more than 2 wt % of the electrolyte.

In some aspects, a battery includes an electrolyte as disclosed herein, an anode, and a cathode comprising a nickel-containing material, wherein the nickel-containing material comprises (A) at least 48 wt % nickel, (B) polycrystalline LiNiᵣMnₛCoₜO₂ where r≥0.8, 0≤s≤0.2, 0≤t≤0.2, and r+s+t=1, (C) single crystal LiNiᵣMnₛCoₜO₂ where r≥0.8, 0≤s≤0.2, 0≤t≤0.2, and r+s+t=1, (D) polycrystalline LiNiᵣCoₛAlₜO₂ where r≥0.8, 0≤s≤0.2, 0≤t≤0.2, and r+s+t=1, or (E) single crystal LiNiᵣCoₛAlₜO₂ where r≥0.8, 0≤s≤0.2, 0≤t≤0.2, and r+s+t=1. In certain implementations, the cathode may be any one of (B)-(E) and the cathode may further comprise a dopant, wherein the dopant is boron, Mg, Si, Ti, Al, Zn, Fe, Zr, Sn, Sc, V, Cr, Fe, Cu, Ga, Y, N, Mo, Ru, Ta, W, Ir, Ce, or any combination of two or more thereof, and a molar ratio of the dopant to Li is not greater than 0.05.

In any of the foregoing or following aspects, the cathode may further include a coating material on at least a portion of an exposed surface of the nickel-containing material. In some aspects, the coating material comprises Al₂O₃, ZrO₂, ZnO, SiO₂, MgO, TiO₂, B₂O₃, AlPO₄, AlF₃, LiNbO₃, or any combination of two or more thereof, and a weight percentage of the coating material relative to a weight of the nickel-containing material is not more than 3 wt %.

Exemplary anodes include, but are not limited to, lithium metal, nanocrystalline or microcrystalline silicon, silicon oxide (SiO_{q} where 0<q≤2), silicon-metal alloys, silicon-carbon mixtures, Li₄Ti₅O₁₂, and carbonaceous materials comprising hard carbon, soft carbon, or graphite.

The foregoing and other objects, features, and advantages of the disclosure will become more apparent from the following detailed description, which proceeds with reference to the accompanying figures.

### BRIEF DESCRIPTION OF THE DRAWINGS

FIG. 1 is a schematic diagram of an exemplary lithium ion battery.

FIG. 2 is a schematic side elevation view of a simplified pouch cell.

FIG. 3 is a graph of discharge specific capacity as a function of a number of cycles for coin cells comprising (i) polycrystalline LiNi_{0.8}Mn_{0.1}Co_{0.1}O₂ (NMC811)/graphite (Gr) with a specific areal capacity of 3.2 mAh/cm², over a voltage window of 2.6-4.3V; (ii) single crystal LiNi_{0.8}Mn_{0.1}Co_{0.1}O₂ (SC811)/Gr with a specific areal capacity of 3.5 mAh/cm², over a voltage window of 2.6-4.38V; (iii) single crystal LiNi_{0.9}Mn_{0.05}Co_{0.05}O₂ (SC90)/Gr with a specific areal capacity of 3.5 mAh/cm², over a voltage window of 2.6-4.23V; and (iv) boron-doped SC90 (SC90B)/Gr with a specific areal capacity of 3.0 mAh/cm², over a voltage window of 2.6-4.23V. All cells included an electrolyte comprising LiFSI:DME:TFT at a molar ratio of 1:0.8:2.4, and were operated at a charge/discharge rate of 0.33 C/0.33 C.

FIG. 4 is a graph of discharge specific capacity as a function of a number of cycles for a coin cell comprising NMC811/Li with a specific areal capacity of 4.2 mAh/cm², over a voltage window of 2.7-4.4V, at a charge/discharge rate of 0.1 C/0.33 C. The electrolyte was LiFSI:DME:TFT at a molar ratio of 1:0.8:2.4.

FIG. 5 is a graph of discharge specific capacity as a function of a number of cycles for a coin cell comprising LiNi_{0.6}Mn_{0.2}Co_{0.2}O₂ (NMC622)/Si-Gr with a specific areal capacity of 3.6 mAh/cm², over a voltage window of 2.0-4.38V, at a charge/discharge rate of 0.33 C/0.33 C. The electrolyte was LIFSI:DME:TFT at a molar ratio of 1:0.8:2.4.

FIG. 6 is a graph of discharge specific capacity as a function of a number of cycles for coin cells comprising (i) NMC811/Gr with a specific areal capacity of 3.9 mAh/cm², over a voltage window of 2.6-4.38V, at a charge/discharge rate of 0.33 C/0.33 C; (ii) SC90/Gr with a specific areal capacity of 2.3 mAh/cm², over a voltage window of 2.6-4.2V, at a charge/discharge rate of 1 C/1 C; (iii) SC811/Gr with a specific areal capacity of 2.5 mAh/cm², over a voltage window of 2.6-4.2V, at a charge/discharge rate of 1 C/1 C; and (iv) SC811R/Gr with a specific areal capacity of 2.3 mAh/cm², over a voltage window of 2.6-4.2V, at a charge/discharge rate of 1 C/1 C. All cells included an electrolyte comprising LiFSI:MTE:TFT at a molar ratio of 1:4:5 with additives comprising 2 wt % EC, 1 wt % LiPO₂F₂, 0.5 wt % VC, and 0.5 wt % FEC.

FIG. 7 is a graph of discharge specific capacity as a function of a number of cycles for a coin cell comprising NMC811/Gr with a specific areal capacity of 3.3 mAh/cm², over a voltage window of 2.7-4.3V, at a charge/discharge rate of 0.33 C/0.33 C. The electrolyte was LiFSI:DMC:TFT at a molar ratio of 1:4:5 with additives comprising 2 wt % EC, 1 wt % LiPO₂F₂, 0.5 wt % VC, and 0.5 wt % FEC.

FIG. 8 is a graph of discharge specific capacity as a function of a number of cycles for coin cells comprising NMC811/Gr with a specific areal capacity of 3.2 mAh/cm², over a voltage window of 2.6-4.3V, at charge/discharge rates of 0.33 C/0.33 C, 1 C/1 C, and 2 C/2 C. The electrolyte was 2 M LiFSI in 1-methoxy-2-(trifluoromethoxy) ethane with 1 wt % TFT.

FIG. 9 is a graph of discharge specific capacity as a function of a number of cycles for a coin cell comprising NMC90/Li with a specific areal capacity of 3.9 mAh/cm², over a voltage window of 2.7-4.4V, at a charge/discharge rate of 0.1 C/0.33 C. The electrolyte was 3 M LiFSI in 1-methoxy-2-(trifluoromethoxy) ethane with 1 wt % TFT.

### DETAILED DESCRIPTION

Aspects of an electrolyte for use in secondary lithium batteries comprising a nickel-rich cathode are disclosed, along with aspects of secondary lithium batteries including the electrolyte. The disclosed electrolyte aspects include lithium bis(fluorosulfonyl)imide (LiFSI), a solvent system comprising a first solvent and a fluorinated cyclic ether having a molecular weight greater than 110 g/mol, and an optional additive. In some aspects, the first solvent comprises a carbonate, an ester, an ether, a fluorinated carbonate, a fluorinated ester, a fluorinated ether, or any combination thereof. In some aspects, the solvent system comprises at least 50 wt % of the fluorinated cyclic ether.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various embodiments of the disclosure, the following explanations of specific terms are provided:

Additive: As used herein, the term “additive” refers to a component of an electrolyte that is present in an amount of greater than zero and less than or equal to 10 wt % or less than or equal to 20 mol % of the electrolyte. When two or more additives are present, the total quantity of additives in the electrolyte is an amount of greater than zero and less than or equal to 10 wt % or less than or equal to 20 mol % of the electrolyte.

Anode: An electrode through which electric charge flows into a polarized electrical device. From an electrochemical point of view, negatively-charged anions move toward the anode and/or positively-charged cations move away from it to balance the electrons leaving via external circuitry. In a discharging battery or galvanic cell, the anode is the negative terminal where electrons flow out. If the anode is composed of a metal, electrons that it gives up to the external circuit are accompanied by metal cations moving away from the electrode and into the electrolyte. When the battery is recharged, the anode becomes the positive terminal where electrons flow in and metal cations are reduced. Unless otherwise specified, the term “anode” as used herein, refers to the negative electrode or terminal where electrons flow out during discharge.

C-rate: The speed at which a battery is fully charged or discharged. A C-rate of 1 C means the battery is fully charged (0-100%) or fully discharged (100-0%) in one hour. A C-rate of 0.33 C means the battery is ⅓ charged or ⅓ discharged in one hour or, conversely, the battery requires 3 hours to fully charge or fully discharge at a C-rate of 0.33 C.

Cathode: An electrode through which electric charge flows out of a polarized electrical device. From an electrochemical point of view, positively charged cations invariably move toward the cathode and/or negatively charged anions move away from it to balance the electrons arriving from external circuitry. In a discharging battery or galvanic cell, the cathode is the positive terminal, toward the direction of conventional current. This outward charge is carried internally by positive ions moving from the electrolyte to the positive cathode, where they may be reduced. When the battery is recharged, the cathode becomes the negative terminal where electrons flow out and metal atoms (or cations) are oxidized. Unless otherwise specified, the term “cathode” as used herein, refers to the positive electrode during discharge.

Cell: As used herein, a cell refers to an electrochemical device used for generating a voltage or current from a chemical reaction, or the reverse in which a chemical reaction is induced by a current. A battery includes one or more cells. The terms “cell” and “battery” are used interchangeably when referring to a battery containing only one cell.

Consists essentially of: By “consists essentially of,” it is meant that the electrolyte does not include other components that materially affect the properties of the electrolyte alone or in a system including the electrolyte. Electrolyte properties include, but are not limited to, Coulombic efficiency, cycling stability, voltage window, conductivity, viscosity, volatility, and flammability. For example, the electrolyte does not include any electrochemically active component (i.e., a component, such as an element, an ion, or a compound, that is capable of forming redox pairs having different oxidation and reduction states, e.g., ionic species with differing oxidation states or a metal cation and its corresponding neutral metal atom) other than the lithium salt in an amount sufficient to affect performance of the electrolyte, and does not include additional solvents, diluents, or additives, besides those listed, in a significant amount (e.g., greater than 1 wt %).
DMC: dimethyl carbonate
DME: dimethoxyethane
DTD: 1,3,2-dioxathiane-2,2-dioxide
EC: ethylene carbonate
EP: ethyl propionate
ES: ethylene sulfite
FEC: fluoroethylene carbonate
LiBOB: lithium bis(oxalato)borate
LIDFOB: lithium difluoro(oxalato)borate
LiDFOP: lithium difluorobis(oxalato)phosphate
LiFSI: lithium bis(fluorosulfonyl)imide
Membrane separator: A porous membrane placed between the anode and cathode. It prevents physical contact between the anode and cathode while facilitating ionic transport.
Microcrystalline: Crystals having a largest dimension of from 1 μm to 1,000 μm.
MMDS: methylene methanedisulfonate
MTE: 1-methoxy-2-(trifluoromethoxy) ethane
Nanocrystalline: Crystals having a largest dimension of less than 1,000 nm.
Nickel-rich: As used herein, the term “nickel-rich” refers to a cathode comprising at least 48 wt % Ni.
Polycrystalline: Characterized by secondary particles made of a plurality of crystals, e.g., secondary particles comprising hundreds or thousands of nanocrystals.
1,3-PS: 1,3-propylene sulfite
Single crystal: Characterized by individual crystals.
Specific capacity: A term that refers to capacity per unit of mass. Specific capacity may be expressed in units of mAh/g.
Specific areal capacity: A term that refers to capacity per unit of area of the electrode (or active material). Specific areal capacity may be expressed in units of mAh/cm².
TFPi: tris(2,2,2-trifluoroethyl) phosphite
TFT: 3,3,4,4-tetrafluorotetrahydrofuran
THF: tetrahydrofuran
VC: vinylene carbonate
VEC: vinyl ethylene carbonate, 4-vinyl-1,3-dioxolan-2-one

### II. Electrolytes

Aspects of electrolytes for use in secondary lithium batteries with nickel-rich cathodes are disclosed. Nickel-rich cathodes provide secondary lithium batteries with high capacity, but battery stability can be compromised due to poor interface stability between the nickel-rich cathode material and the electrolyte. In some aspects, the disclosed electrolytes enhance interface stability, particularly the cathode-electrolyte interface, thereby providing superior cycling of secondary lithium batteries including a Ni-rich material.

Aspects of the disclosed electrolytes comprise lithium bis(fluorosulfonyl)imide (LiFSI), a solvent system comprising a first solvent and a fluorinated cyclic ether having a molecular weight greater than 110 g/mol (hereinafter referred to as the “fluorinated cyclic ether”), and optionally an additive. The first solvent is a carbonate, an ester, an ether, a fluorinated carbonate, a fluorinated ester, a fluorinated ether, or any combination thereof. The fluorinated cyclic ether makes up at least 50 wt % of the solvent system. The fluorinated cyclic ether does not comprise a component of the first solvent. The solvent system does not comprise a combination of a non-fluorinated acyclic ether and a fluorinated acyclic ether having a fluorination ratio≥60%, wherein a molar ratio of the non-fluorinated acyclic ether to the fluorinated cyclic ether is within a range of 0.25-3 and a molar ratio of the fluorinated acyclic ether to the fluorinated cyclic ether is within a range of 0.5-6. Alternatively stated, if the solvent system comprises a combination of a non-fluorinated acyclic ether and a fluorinated acyclic ether having a fluorination ratio≥60%, then a molar ratio of the non-fluorinated acyclic ether to the fluorinated cyclic ether is not within a range of 0.25-3 and/or a molar ratio of the fluorinated acyclic ether to the fluorinated cyclic ether is not within a range of 0.5-6. If an additive is present, the additive does not comprise a component of the first solvent or the fluorinated cyclic ether.

The solvent system includes a first solvent and a fluorinated cyclic ether as set forth above. Advantageously, LiFSI is soluble in the first solvent, and the fluorinated cyclic ether enhances the cathode-electrolyte interface stability. In some aspects, the fluorinated cyclic ether exhibits a high wetting capability. In certain aspects, additives are included to further enhance the cathode-electrolyte interfacial stability and/or the anode-electrolyte interfacial stability (e.g., for anodes comprising graphite and/or silicon).

In any of the foregoing or following aspects, the electrolyte includes x moles LiFSI, y moles of the first solvent, and z moles of the fluorinated cyclic ether. In some aspects, a molar ratio of x:y:z is 1:0.05-10:0.05-10. Because the fluorinated cyclic ether comprises at least 50 wt % of the solvent system, z≥y. In some implementations, y is 0.05-5, 0.5-5, 0.5-1, 0.8-4, 1-5, or 3-5, and z is 1-10, 1.5-10, 1.5-5, 1.5-3.5, 2-8, 2-5, or 4-6. In certain implementations, the molar ratio of x:y:z is 1:0.5-5:2-8, or 1:0.8-4:2-5. In one example, the molar ratio is 1:0.8:2.4. In an independent example, the molar ratio is 1:4:5.

As disclosed herein, the first solvent comprises a carbonate, an ester, an ether, a fluorinated carbonate, a fluorinated ester, a fluorinated ether, or any combination thereof. Each of the carbonates, esters, and ethers may be cyclic or acyclic wherein any cyclic ethers that are fluorinated and form part of the first solvent have molecular weights that are less than that of the weight requirement for the fluorinated cyclic ether (e.g., the cyclic ethers that are fluorinated have weights of no more than 110 g/mol, no more than 124 g/mol, or no more than 144 g/mol). Fluorinated carbonates, esters, and ethers include one or more fluorine atoms and may be cyclic or acyclic. Exemplary first solvents include, but are not limited to, dimethoxyethane (DME), 1-methoxy-2-(trifluoromethoxy) ethane (MTE), dimethyl carbonate (DMC), ethyl propionate (EP), or any combination of two or more thereof.

The fluorinated cyclic ether (that forms a second part of the solvent system) has a molecular weight greater than 110 g/mol. In some aspects, the fluorinated cyclic ether has a molecular weight greater than 124 g/mol or greater than 140 g/mol. The solvent system comprises at least 50 wt % fluorinated cyclic ether. In some aspects, the solvent system comprises at least 55 wt %, at least 60 wt %, at least 65 wt %, or at least 70 wt % fluorinated cyclic ether. In certain aspects, the solvent system comprises 50 wt % to 80 wt % fluorinated cyclic ether, such as 50 wt % to 75 wt % or 55 wt % to 75 wt % fluorinated cyclic ether. Advantageously, LiFSI has very limited solubility or is insoluble in the fluorinated cyclic ether. For example, LiFSI may have a solubility in the first solvent at least 10 times greater than the solubility of LiFSI in the fluorinated cyclic ether.

In any of the foregoing or following aspects, the fluorinated cyclic ether may comprise a 5-membered ring or a 6-membered ring, such as a fluorinated tetrahydrofuran or fluorinated tetrahydropyran. In some implementations, the fluorinated cyclic ether does not comprise a 6-membered ring and/or is not a fluorinated tetrahydropyran. In some aspects, the fluorinated cyclic ether comprises a fluorinated tetrahydrofuran having a formula C₄HₘFₙO where m+n=8, and the fluorinated tetrahydrofuran has a molecular weight of greater than 110 g/mol. In certain aspects, the fluorinated cyclic ether is 3,3,4,4,-tetrafluorotetrahydrofuran (TFT). In an independent aspect, the fluorinated cyclic ether comprises a fluorinated tetrahydropyran having a formula C₅HₘFₙO where m+n=10, and the fluorinated tetrahydropyran has a molecular weight of greater than 110 g/mol.

In any of the foregoing or following aspects, the fluorinated cyclic ether may comprise a combination of two or more fluorinated cyclic ethers with each fluorinated cyclic ether having a molecular weight greater than 110 g/mol. In such aspects, a total amount of the two or more fluorinated cyclic ethers forms at least 50 wt % of the solvent system. Thus, in some aspects, the solvent system comprises at least 50 wt %, at least 55 wt %, at least 60 wt %, at least 65 wt %, or at least 70 wt % of a combination of fluorinated cyclic ethers. In some implementations, each fluorinated cyclic ether has a molecular weight greater than 124 g/mol or greater than 140 g/mol. In some aspects, fluorinated cyclic ethers having weights less than or equal to 110 g/mol may be included in the electrolyte as part of the first solvent.

Aspects of the disclosed electrolytes may comprise an additive. The additive does not comprise a component of the first solvent or the fluorinated cyclic ether. In some aspects, the electrolyte comprises a plurality of additives. In some implementations, each additive independently is present in an amount of not more than 5 wt % of the electrolyte, such as an amount greater than zero and up to 5 wt %, an amount greater than zero and up to 4 wt %, an amount greater than zero and up to 3 wt %, an amount greater than zero and up to 2 wt %, 0.1 wt % to 5 wt %, 0.2 wt % to 5 wt %, 0.5 wt % to 5 wt %, 0.5 wt % to 4 wt %, 0.5 wt % to 3 wt %, or 0.5 wt % to 2 wt %. In any of the foregoing or following aspects, the total amount of additives in the electrolyte may be from zero to 5 wt %, such as from greater than zero to 4 wt %. Exemplary additives include, but are not limited to, (i) vinylene carbonate (VC), (ii) ethylene carbonate (EC), (iii) fluoroethylene carbonate (FEC), (iv) vinyl ethylene carbonate (VEC), (v) LiPO₂F₂, (vi) lithium bis(oxalato)borate (LiBOB), (vii) lithium difluoro(oxalato)borate (LiDFOB), (viii) lithium difluorobis(oxalato)phosphate (LiDFOP), (ix) LiNO₃, (x) tris(2,2,2-trifluoroethyl) phosphite (TFPi), (xi) ethylene sulfite (ES), (xii) 1,3-propylene sulfite (1,3-PS), (xiii) 1,3,2-dioxathiane-2,2-dioxide (DTD), (xiv) methylene methanedisulfonate (MMDS), or (xv) any combination of at least two of (i) to (xiv). In one implementation, the electrolyte does not comprise an additive. In an independent implementation, the electrolyte comprises a single additive. In another independent implementation, the electrolyte comprises a plurality of additives. In some aspects, the additive comprises EC, LiPO₂F₂, VC, FEC, or any combination thereof. In certain aspects, the additives comprise EC, LiPO₂F₂, VC, and FEC.

In any of the foregoing or following implementations, the electrolyte may consist essentially of, or consist of: LiFSI, the first solvent, and the fluorinated cyclic ether. In some implementations, the electrolyte consists essentially of, or consists of, LiFSI, the first solvent, the fluorinated cyclic ether, and any additives according to the present disclosure. In certain implementations, the electrolyte does not include any lithium salt other than LiFSI in an amount greater than 5 wt %, or an amount greater than 2 wt %, or an amount greater than 1 wt %. In some examples, the electrolyte does not include: (i) any first solvent other than those recited herein; or (ii) any fluorinated cyclic ether other than those recited herein; or (iii) any additives other than those recited herein; or (iv) any combination of two or more of (i), (ii), and (iii).

In some aspects, the electrolyte comprises: LiFSI and a solvent system wherein the first solvent comprises DME and the fluorinated cyclic ether comprises TFT. In one example, the electrolyte comprises: LiFSI and a solvent system wherein the first solvent comprises DME, the fluorinated cyclic ether comprises TFT, and the molar ratio of x:y:z is 1:0.5-1:1.5-3.5. In some aspects, the electrolyte comprises: LiFSI and a solvent system wherein the first solvent comprises MTE, the fluorinated cyclic ether comprises TFT, and additives are included and comprise EC, LiPO₂F₂, VC, and FEC. In one example, the electrolyte comprises: (i) LiFSI, (ii) a solvent system wherein the first solvent comprises MTE, the fluorinated cyclic ether comprises TFT, and the molar ratio of x:y:z is 1:3-5:4-6, and (iii) additives wherein the additives comprise 1 wt % to 3 wt % EC, 0.5 wt % to 1.5 wt % LiPO₂F₂, 0.1 wt % to 1 wt % VC, and 0.1 wt % to 1 wt % FEC, and wherein a total amount of the additives does not exceed 5 wt %. In some aspects, the electrolyte comprises: LiFSI, a solvent system wherein the first solvent comprises DMC and the fluorinated cyclic ether comprises TFT, and additives wherein the additives comprise EC, LiPO₂F₂, VC, and FEC. In one example, the electrolyte comprises: (i) LiFSI, (ii) a solvent system wherein the first solvent comprises DMC, the fluorinated cyclic ether comprises TFT, and the molar ratio of x:y:z is 1:3-5:4-6, and (iii) additives wherein the additives comprise 1 wt % to 3 wt % EC, 0.5 wt % to 1.5 wt % LiPO₂F₂, 0.1 wt % to 1 wt % VC, and 0.1 wt % to 1 wt % FEC, and wherein a total amount of the additives does not exceed 5 wt %.

In any of the foregoing or following aspects, the electrolyte may not include a lithium salt other than LiFSI in an amount greater than 5 wt %. In any of the foregoing or following aspects, the electrolyte may not include any single lithium-containing additive in an amount greater than 5 wt % or an amount greater than 2 wt %. In some aspects, the electrolyte does not comprise a combination of lithium-containing additives in a total amount greater than 5 wt % or in a total amount greater than 2 wt %. In some aspects, the electrolyte does not include a fluorinated acyclic ether having a fluorination ratio of 60% or more, wherein the fluorination ratio is a percentage of hydrogen atoms in the corresponding non-fluorinated acyclic ether that are replaced by fluorine atoms to provide the fluorinated acyclic ether. For example, 1,1,2,2-tetrafluoroethyl-2,2,2-trifluoroethyl ether has a fluorination ratio of 70% (7 of 10 hydrogen atoms replaced by fluorine atoms). In certain aspects, the fluorinated cyclic ether does not comprise 3,3,4,4,5,5-hexafluorotetrahydropyran. In some implementations, the electrolyte does not include EC, PC, or a combination thereof, in an amount ≥5 wt %.

### III. Batteries

The disclosed electrolytes are useful in battery systems, such as secondary or rechargeable batteries. In some embodiments, the disclosed electrolytes are useful in lithium ion or lithium metal batteries. In some embodiments, a system comprises an electrolyte as disclosed herein, an anode, and a cathode. The system may further comprise a membrane separator positioned between the anode and cathode, an anode current collector, a cathode current collector, or any combination thereof. In some implementations, the battery system comprises a casing, wherein the casing provides electrically isolated electrical connections to the anode and to the cathode.

In any of the foregoing or following aspects, the cathode may be a nickel-rich cathode. Suitable materials for the cathode include nickel and nickel-rich intercalation compounds. In some aspects, the cathode comprises a nickel-containing material comprising (A) at least 48 wt % nickel, (B) polycrystalline LiNiᵣMnₛCoₜO₂ where r≥0.8, 0≤s≤0.2, 0≤t≤0.2, and r+s+t=1, (C) single crystal LiNiᵣMnₛCoₜO₂ where r≥0.8, 0≤s≤0.2, 0≤t≤0.2, and r+s+t=1, (D) polycrystalline LiNiᵣCoₛAlₜO₂ where r≥0.8, 0≤s≤0.2, 0≤t≤0.2, and r+s+t=1, or (E) single crystal LiNiᵣCoₛAlₜO₂ where r≥0.8, 0≤s≤0.2, 0≤t≤0.2, and r+s+t=1. In certain aspects, the cathode comprises any one of (B)-(E) where r≥0.9, 0≤s≤0.1, 0≤t≤0.1, 0<s+t≤0.1, and r+s+t=1. In some implementations, the cathode comprises any one of (B)-(E) where r≥0.8, 0<s≤0.2, 0<t≤0.2, 0<s+t≤0.2, and r+s+t=1. In certain implementations, the cathode comprises any one of (B)-(E) where r≥0.9, 0<s≤0.1, 0<t≤0.1, 0<s+t≤0.1, and r+s+t=1.

In any of the foregoing or following aspects, the cathode may comprise any one of (B)-(E) and a dopant. In some aspects, the dopant is boron, Mg, Si, Ti, Al, Zn, Fe, Zr, Sn, Sc, V, Cr, Fe, Cu, Ga, Y, N, Mo, Ru, Ta, W, Ir, Ce, or any combination of two or more thereof. In certain aspects, a molar ratio of the dopant to Li is not greater than 0.05. In some examples, the dopant is boron.

In some examples, the nickel-containing material comprises polycrystalline LiNi_{0.8}Mn_{0.1}Co_{0.1}O₂ (NMC811), single crystal LiNi_{0.8}Mn_{0.1}Co_{0.1}O₂ (SC811), polycrystalline LiNi_{0.9}Mn_{0.05}Co_{0.05}O₂ (NMC90) single crystal LiNi_{0.9}Mn_{0.05}Co_{0.05}O₂ (SC90), or boron-doped SC90. In certain implementations, the nickel-containing material is a recycled nickel-containing material. Exemplary methods for producing a recycled nickel-rich cathode material are disclosed in US 2024/0145801 A1, the relevant portion of which is incorporated by reference herein.

In any of the foregoing or following aspects, the cathode may further include a coating material on at least a portion of an exposed surface of the nickel-containing material. In some aspects, the coating material comprises Al₂O₃, ZrO₂, ZnO, SiO₂, MgO, TiO₂, B₂O₃, AlPO₄, AlF₃, LiNbO₃, or any combination of two or more thereof. In certain implementations, a weight percentage of the coating material relative to a weight of the nickel-containing material is not more than 3 wt %.

Suitable anodes include anodes comprising lithium metal, silicon, silicon oxides, silicon-metal alloys, silicon-carbon mixtures, Li₄Ti₅O₁₂ (LTO), and carbonaceous materials. In some aspects, the anode comprises lithium metal, nanocrystalline silicon, microcrystalline silicon, silicon oxide (SiO_{q} where 0<q≤2), a silicon-metal alloy wherein the metal is Fe, Sn, Ti, Mn, Ni, Cu, or any combination or two or more thereof, a silicon-carbon mixture, Li₄Ti₅O₁₂ (LTO), or a carbonaceous material comprising hard carbon, soft carbon, or graphite (Gr). In an independent implementation, the anode is lithium metal. In another independent implementation, the anode is a Gr anode, such an anode where at least 70 wt %, at least 80 wt %, or at least 90 wt % of the total anode mass is Gr. In yet another independent implementation, the anode is a Si/Gr mixture, such as an anode where a majority of the total anode mass is Gr and silicon, such as at least 70 wt %, at least 80 wt %, or at least 95 wt % of a combination of Gr and silicon.

The anode may further include one or more binders and/or conductive additives. Suitable binders include, but are not limited to, polyacrylates (e.g., lithium polyacrylate, LiPAA), polyimides (PI), polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives).

In any of the foregoing aspects, the battery system may comprise a separator between the anode and the cathode. The separator may be a membrane, such as a porous polymer film (e.g., polyethylene- or polypropylene-based material). One exemplary polymeric separator is a Celgard® K1640 polyethylene (PE) membrane. Another exemplary polymeric separator is a Celgard® 2500 polypropylene membrane. Another exemplary polymeric separator is a Celgard® 3501 surfactant-coated polypropylene membrane.

In any of the foregoing or following implementations, the current collectors, if present, can be a metal or another conductive material such as, but not limited to, nickel (Ni), copper (Cu), aluminum (Al), iron (Fe), stainless steel, or conductive carbon materials. The current collector may be a foil, a foam, or a polymer substrate coated with a conductive material. Advantageously, the current collector is stable (i.e., does not corrode or react) when in contact with the anode or cathode and the electrolyte in an operating voltage window of the battery. The anode and cathode current collectors may be omitted if the anode or cathode, respectively, are free standing, e.g., when the anode is lithium metal or other free standing material, and/or when the cathode is a free standing material. By “free standing” is meant that the anode or cathode material itself has sufficient structural integrity that the anode or cathode can be positioned in the battery without a support material.

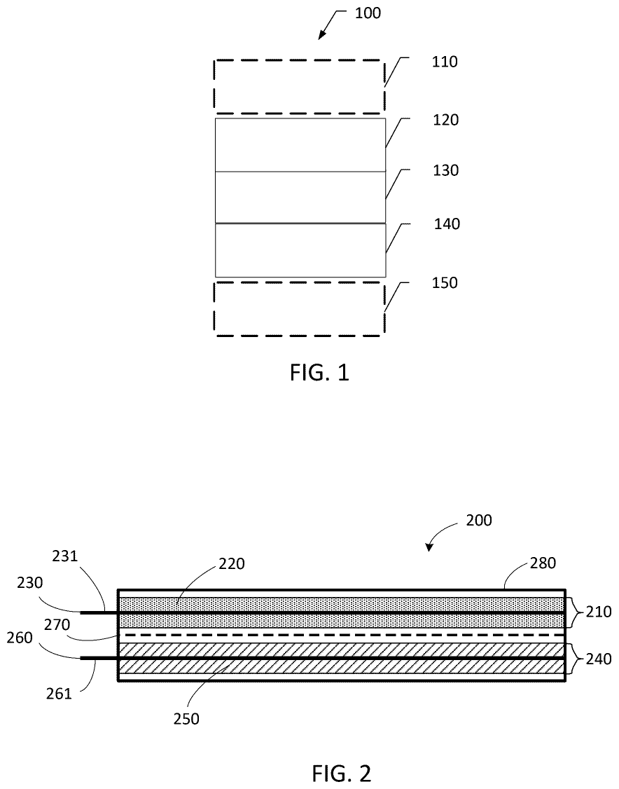

FIG. 1 is a schematic diagram of one exemplary aspect of a secondary lithium battery 100 including a nickel-rich cathode 120, a separator 130 which is infused with an electrolyte as disclosed herein, and an anode 140. In some aspects, the battery 100 also includes a cathode current collector 110 and/or an anode current collector 150.

In any of the foregoing or following aspects, the secondary lithium battery may be a pouch cell. FIG. 2 is a schematic side elevation view of one implementation of a simplified pouch cell 200. The exemplary pouch cell 200 comprises an anode 210, an anode current collector 230, a nickel-rich cathode 240 comprising a nickel-containing material 250 as disclosed herein and a cathode current collector 260, a separator 270, and a packaging material defining a casing or pouch 280 enclosing the anode 210, cathode 240, and separator 270. The pouch 280 further encloses an electrolyte as disclosed herein (not shown). The anode current collector 230 has a protruding tab 231 that extends external to the pouch 280, and the cathode current collector 260 has a protruding tab 261 that extends external to the pouch 280. The pouch or casing 280 provides electrically isolated electrical connections to the anode and to the cathode via the protruding tabs 231, 261 that extend external to the pouch 280.

In any of the foregoing aspects, a secondary lithium battery having a Ni-rich cathode and comprising an electrolyte as disclosed herein may provide a discharge specific capacity retention of at least 75%, at least 80%, at least 85%, or at least 90% after 500 cycles at a charge rate of 0.3 C to 1 C and a discharge rate of 0.3 C to 1 C. In some aspects, the secondary lithium battery provides a discharge specific capacity retention of at least 75%, at least 80%, at least 85%, or at least 90% after 600 cycles, 800 cycles, or even 1000 cycles at a charge rate of 0.3 C to 1 C and a discharge rate of 0.3 C to 1 C.

### IV. Examples

Electrode preparation: NMC cathodes were prepared by following procedures. 1) NMC active material, carbon black and PVDF binder with a weight ratio of 96:2:2 were mixed in a dry room. 2) N-methyl-2-pyrrolidone (NMP) solvent was added to the mixture in (1) until the solid content reached ˜50 wt %. 3) The slurry was mixed with a Thinky mixer (Thinky, Laguna Hills, CA) to provide a uniform slurry. 4) The slurry was coated with a doctor blade onto aluminum foil and the coated electrode was dried in a vacuum oven. The material loading was controlled to 16-20 mg/cm². 5) The electrode was calendared to a density of 3.0 g/cm³. 6) The cathode electrode was punched to provide a round disk of 12.7 mm diameter. All single crystal NMC materials were synthesized as described in US20220112094A1, which is incorporated herein by reference.

Graphite anodes were made by following procedures. 1) Graphite material, carbon black and PVDF binder with a weight ratio of 95:2:3 were mixed. 2) NMP solvent was added to the mixture in (1) until the solid content reached ˜50 wt %. 3) The slurry was mixed with a Thinky mixer to provide a uniform slurry. 4) The slurry was coated with a doctor blade onto copper foil and the coated electrode was dried in a vacuum oven. The material loading was controlled to 9-12 mg/cm². 5) The electrode was calendared to a density of 1.5 g/cm³. 6) The anode electrode was punched to provide a round disk of 14 mm diameter. The N/P ratio of anode capacity and cathode capacity was around 1.1.

A graphite/Si electrode was made by following procedure. Nanocrystalline Si was mixed with graphite in a weight ratio of 60:40 by manually grinding with a mortar. The weight ratio of Si, graphite, carbon black and polyimide (PI) binder in the Si-Gr anode was 52.8:35.2:4:8. A slurry prepared with NMP solvent was mixed by a Thinky mixer and coated onto 18 μm Cu foil. The material loading was 2.1-3.0 mg/cm² and the electrode was calendared to 1.05 g/cm³. After drying at 70° C. overnight, the electrode was punched to provide a round disk 16 mm diameter for full cell assembly. The punched electrode was treated at 300° C. for 2 h under argon flow to cure the polyimide prior to cell assembly. A filtering process with a 325 mesh stainless steel sieve having 0.002″ of opening size was applied after mixing to achieve a filtered Si-Gr electrode.

Electrolyte preparation: All electrolytes were prepared in an argon-filled glovebox with the molar ratios and additive amounts described below.

Cell assembly and testing: The cells were ϕ032 coin cells evaluated at 25° C.

NMC/Gr cells: 2032-coin cells with a ϕ12.7 mm NMC cathode and ϕ14 mm Gr anode having a N/P ratio of 1.1 were assembled in an argon-filled glovebox. Electrolyte, 70 μL, was added to each coin cell. After resting 24 h, the cells were subjected to three formation cycles charged/discharged at 0.1 C, followed by 0.33 C/0.33 C (or 1 C/1 C or 2 C/2 C) for cycling testing. The working voltage was 2.6-4.3 V (or as otherwise specified), and a constant voltage charge at 4.3 V was applied after each charge (0.33 C, 1 C, or 2 C) and ended when the current rate reached 0.05 C.

NMC/Li cells: 2032-coin cells with a ϕ12.7 mm NMC cathode and ϕ16 mm lithium metal anode having a thickness of 50 μm were assembled in an argon-filled glovebox. Electrolyte, 15 μL, was added to each coin cell. After resting 24 h, the cells were subjected to two formation cycles charged/discharged at 0.1 C, followed by 0.1 C/0.33 C for cycling testing. The working voltage was 2.7-4.4 V.

NMC622/Si-Gr cells: 2032-coin cells with a ϕ12.7 mm NMC622 cathode and ϕ16 mm Si-Gr anode having a N/P ratio of 1.5-1.6 were assembled in an argon-filled glovebox. Electrolyte, 70 μL, was added to each coin cell. After resting 24 h, the cells were subjected to two formation cycles charged/discharged at 0.1 C, followed by 0.33 C/0.33 C for cycling. The working voltage was 2.0-4.38 V, and a constant voltage charge at 4.38 V was applied after each charge at 0.33 C and ended when the current rate reached 0.05 C. Prior to full cell assembly, the Si-Gr electrodes were prelithiated to reduce the large irreversible capacity at first cycle. The electrochemical prelithiation of Si-Gr electrodes was performed in Li metal/Si-Gr 2032-coin cells. After the Li metal/Si-Gr half-cell was discharged to 0.1 V at 0.1 C (45-50% state-of-charge (SOC)), the cell was disassembled to harvest the pre-lithiated Si-Gr electrode and coupled with the NMC622 electrode to assemble the full cell for the cycling test.

### Results

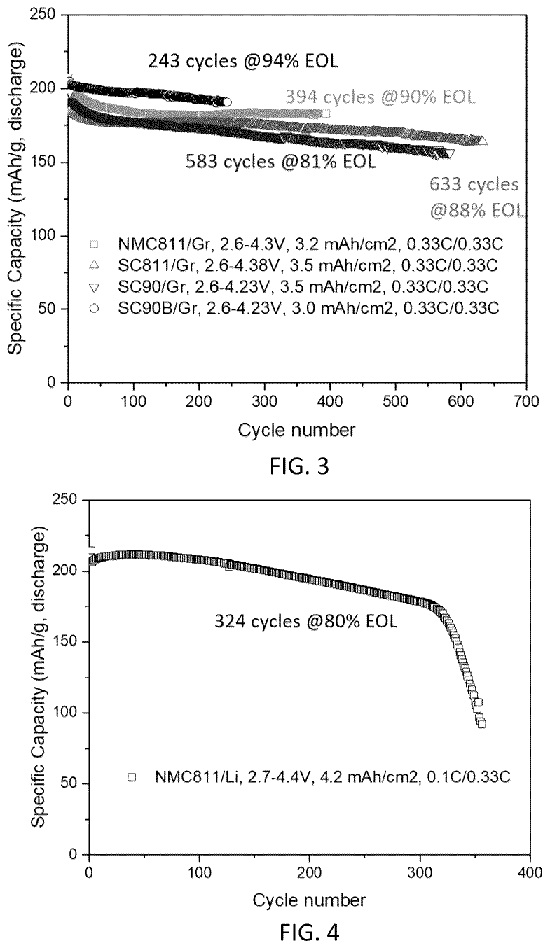

Coin cells were prepared with varying NMC/Gr electrodes and an electrolyte comprising LIFSI:DME:TFT at a molar ratio of 1:0.8:2.4. The following cells were evaluated at charge/discharge rates of 0.33 C/0.33 C: (i) polycrystalline LiNi_{0.8}Mn_{0.1}Co_{0.1}O₂ (NMC811)/graphite (Gr) with a specific areal capacity of 3.2 mAh/cm², over a voltage window of 2.6-4.3V; (ii) single crystal LiNi_{0.8}Mn_{0.1}Co_{0.1}O₂ (SC811)/Gr with a specific areal capacity of 3.5 mAh/cm², over a voltage window of 2.6-4.38V; (iii) single crystal LiNi_{0.9}Mn_{0.05}Co_{0.05}O₂ (SC90)/Gr with a specific areal capacity of 3.5 mAh/cm², over a voltage window of 2.6-4.23V; and (iv) boron-doped SC90 (SC90B)/Gr with a specific areal capacity of 3.0 mAh/cm², over a voltage window of 2.6-4.23V. As shown in FIG. 3, the SC90B/Gr cell had a discharge specific capacity retention of 94% after 243 cycles (and a retention of 90-92% after 400 cycles, not shown), the NMC811/Gr cell had a discharge specific capacity of 90% after 394 cycles, the SC90/Gr cell had a discharge specific capacity of 81% after 583 cycles, and the SC811/Gr cell had a discharge specific capacity of 88% after 633 cycles.

An NMC811/Li coin cell with a specific areal capacity of 4.2 mAh/cm², and with an electrolyte comprising LiFSI:DME:TFT at a molar ratio of 1:0.8:2.4 was operated over a voltage window of 2.7-4.4V at a charge/discharge rate of 0.1 C/0.33 C. As shown in FIG. 4, the cell had a discharge specific capacity of 80% after 324 cycles.

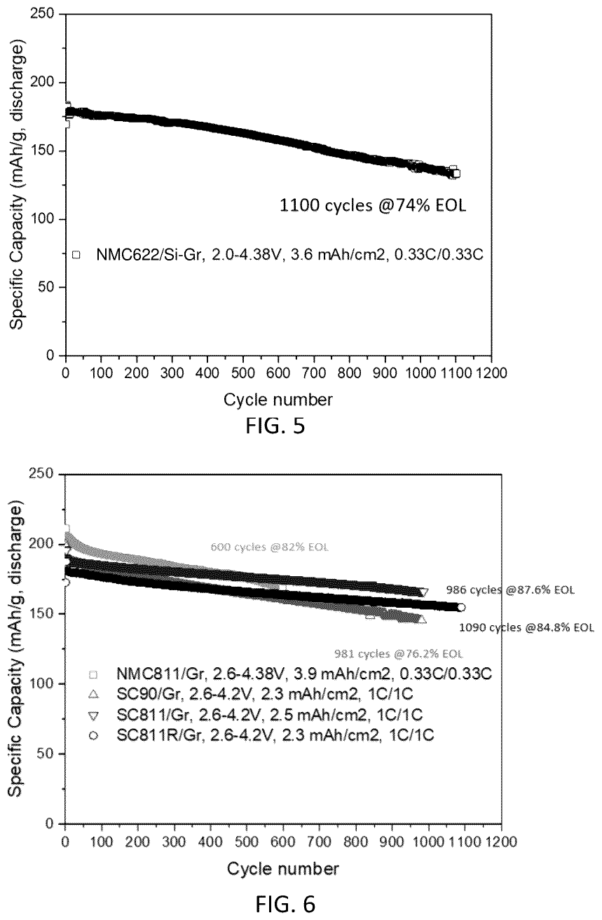

An NMC622/Si-Gr coin cell with a specific areal capacity of 3.6 mAh/cm², and with an electrolyte comprising LiFSI:DME:TFT at a molar ratio of 1:0.8:2.4 was operated over a voltage window of 2.0-4.38V at a charge/discharge rate of 0.33 C/0.33 C. As shown in FIG. 5, the cell had a discharge specific capacity of 74% after 1100 cycles.

Coin cells were prepared with varying NMC/Gr electrodes and an electrolyte comprising LIFSI:MTE:TFT at a molar ratio of 1:4:5 with additives comprising 2 wt % EC, 1 wt % LiPO₂F₂, 0.5 wt % VC, and 0.5 wt % FEC. The following cells were evaluated: (i) NMC811/Gr with a specific areal capacity of 3.9 mAh/cm², over a voltage window of 2.6-4.38V, at a charge/discharge rate of 0.33 C/0.33 C; (ii) SC90/Gr with a specific areal capacity of 2.3 mAh/cm², over a voltage window of 2.6-4.2V, at a charge/discharge rate of 1 C/1 C; (iii) SC811/Gr with a specific areal capacity of 2.5 mAh/cm², over a voltage window of 2.6-4.2V, at a charge/discharge rate of 1 C/1 C; and (iv) SC811R/Gr with a specific areal capacity of 2.3 mAh/cm², over a voltage window of 2.6-4.2V, at a charge/discharge rate of 1 C/1 C. Single crystal SC811R was prepared from recycled polycrystalline NMC811. As shown in FIG. 6, the NMC811/Gr cell had a discharge specific capacity of 82% after 600 cycles, the SC90/Gr cell had a discharge specific capacity of 76.2% after 981 cycles, the SC811/Gr cell had a had a discharge specific capacity of 87.6% after 986 cycles, and the SC811R/Gr cell had a discharge specific capacity of 84.8% after 1090 cycles.

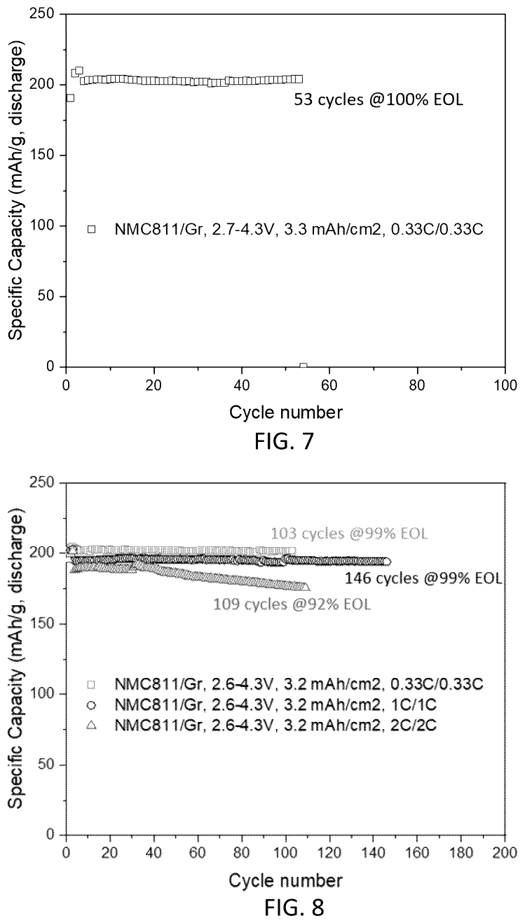

An NMC811/Gr coin cell with a specific areal capacity of 3.3 mAh/cm², and with an electrolyte comprising LiFSI:DMC:TFT at a molar ratio of 1:4:5 with additives comprising 2 wt % EC, 1 wt % LiPO₂F₂, 0.5 wt % VC, and 0.5 wt % FEC was operated over a voltage window of 2.7-4.3V, at a charge/discharge rate of 0.33 C/0.33 C. As shown in FIG. 7, the cell had a discharge specific capacity of 100% after 53 cycles.

Coin cells were prepared with NMC811/Gr electrodes with a specific areal capacity of 3.2 mAh/cm² and operated over a voltage window of 2.6-4.3V, at charge/discharge rates of 0.33 C/0.33 C, 1 C/1 C, and 2 C/2 C. The electrolyte was 2 M LiFSI in MTE with 1 wt % TFT. As shown in FIG. 8, the cell operated at 0.33 C/0.33 C had a discharge specific capacity of 99% after 103 cycles, the cell operated at 1 C/1 C had a discharge specific capacity of 99% after 146 cycles, and the cell operated at 2 C/2 C had a discharge specific capacity of 92% after 109 cycles.

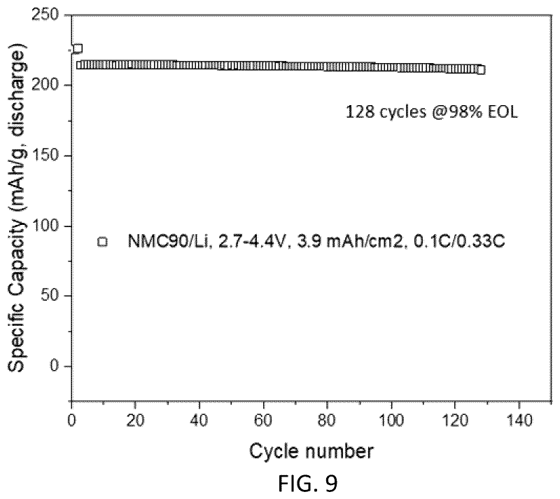

An NMC90/Li coin cell with a specific areal capacity of 3.9 mAh/cm², and with an electrolyte comprising 3 M LiFSI in MTE with 1 wt % TFT was operated over a voltage window of 2.7-4.4V, at a charge/discharge rate of 0.1 C/0.33 C. As shown in FIG. 9, the cell had a discharge specific capacity of 98% after 128 cycles.

In view of the many possible embodiments to which the principles of the disclosed invention may be applied, it should be recognized that the illustrated embodiments are only preferred examples of the disclosure and should not be taken as limiting the scope of the disclosure. Rather, the scope is defined by the following claims. We therefore claim as our invention all that comes within the scope and spirit of these claims.

We claim:

1. An electrolyte, comprising:
lithium bis(fluorosulfonyl)imide (LiFSI); and
a solvent system comprising a first solvent and a fluorinated cyclic ether having a molecular weight greater than 110 g/mol, wherein the first solvent comprises a carbonate, an ester, an ether, a fluorinated carbonate, a fluorinated ester, a fluorinated ether, or any combination thereof,
wherein
(i) the fluorinated cyclic ether does not comprise a component of the first solvent,
(ii) the solvent system comprises at least 50 wt % of the fluorinated cyclic ether, and
(iii) if the solvent system comprises a combination of a non-fluorinated acyclic ether and a fluorinated acyclic ether having a fluorination ratio≥60%, then a molar ratio of the non-fluorinated acyclic ether to the fluorinated cyclic ether is not within a range of 0.25-3 or a molar ratio of the fluorinated acyclic ether to the fluorinated cyclic ether is not within a range of 0.5-6.

2. The electrolyte of claim 1, wherein:
the electrolyte includes x moles LiFSI, y moles of the first solvent, and z moles of the fluorinated cyclic ether; and
a molar ratio of x:y:z is 1:0.05-10:0.05-10.

3. The electrolyte of claim 2, wherein the molar ratio of x:y:z is 1:0.5-5:2-8.

4. The electrolyte of claim 1, wherein the first solvent comprises dimethoxyethane (DME), 1-methoxy-2-(trifluoromethoxy) ethane (MTE), dimethyl carbonate (DMC), ethyl propionate (EP), or any combination of two or more thereof.

5. The electrolyte of claim 1, wherein the fluorinated cyclic ether comprises a 5-membered ring or a 6-membered ring.

6. The electrolyte of claim 1, wherein the fluorinated cyclic ether is a fluorinated tetrahydrofuran.

7. The electrolyte of claim 1, wherein the solvent system comprises at least 60 wt % of the fluorinated cyclic ether.

8. The electrolyte of claim 1, wherein the solvent system comprises at least 70 wt % of the fluorinated cyclic ether.

9. The electrolyte of claim 1, further comprising an additive, wherein:
the additive is (i) vinylene carbonate (VC), (ii) ethylene carbonate (EC), (iii) fluoroethylene carbonate (FEC), (iv) vinyl ethylene carbonate (VEC), (v) LiPO₂F₂, (vi) lithium bis(oxalato)borate (LiBOB), (vii) lithium difluoro(oxalato)borate (LiDFOB), (viii) lithium difluorobis(oxalato)phosphate (LiDFOP), (ix) LiNO₃, (x) tris(2,2,2-trifluoroethyl) phosphite (TFPi), (xi) ethylene sulfite (ES), (xii) 1,3-propylene sulfite (1,3-PS), (xiii) 1,3,2-dioxathiane-2,2-dioxide (DTD), (xiv) methylene methanedisulfonate (MMDS), or (xv) any combination of at least two of (i) to (xiv); and
the additive does not comprise a component of the first solvent or the fluorinated cyclic ether.

10. The electrolyte of claim 1, wherein each additive is present in an amount of not more than 5 wt % of the electrolyte.

11. The electrolyte of claim 1, wherein:
the first solvent comprises DME and the fluorinated cyclic ether comprises 3,3,4,4-tetrafluorotetrahydrofuran (TFT); or
the first solvent comprises MTE, the fluorinated cyclic ether comprises TFT, the electrolyte further comprising a combination of additives comprising EC, LiPO₂F₂, VC, and FEC; or
the first solvent comprises DMC, the fluorinated cyclic ether comprises TFT, the electrolyte further comprising a combination of additives comprising EC, LiPO₂F₂, VC, and FEC.

12. The electrolyte of claim 2, wherein:
the first solvent comprises DME, the fluorinated cyclic ether comprises TFT, and the molar ratio of x:y:z is 1:0.5-1:1.5-3.5; or
the first solvent comprises MTE, the fluorinated cyclic ether comprises TFT, the molar ratio of x:y:z is 1:3-5:4-6, the electrolyte further comprising a combination of additives comprising 1 wt % to 3 wt % EC, 0.5 wt % to 1.5 wt % LiPO₂F₂, 0.1 wt % to 1 wt % VC, and 0.1 wt % to 1 wt % FEC, wherein a total amount of the additives does not exceed 5 wt %; or
the first solvent comprises DMC, the fluorinated cyclic ether comprises TFT, the molar ratio of x:y:z is 1:3-5:4-6, the electrolyte further comprising a combination of additives comprising 1 wt % to 3 wt % EC, 0.5 wt % to 1.5 wt % LiPO₂F₂, 0.1 wt % to 1 wt % VC, and 0.1 wt % to 1 wt % FEC, wherein a total amount of the additives does not exceed 5 wt %.

13. A battery, comprising:
an electrolyte according to claim 1;
an anode; and
a cathode comprising a nickel-containing material, wherein the nickel-containing material comprises (A) at least 48 wt % nickel, (B) polycrystalline LiNiᵣMnₛCoₜO₂ where r≥0.8, 0≤s≤0.2, 0≤t≤ 0.2, and r+s+t=1, (C) single crystal LiNiᵣMnₛCoₜO₂ where r≥0.8, 0≤s≤0.2, 0≤t≤0.2, and r+s+t=1, (D) polycrystalline LiNiᵣCoₛAlₜO₂ where r≥0.8, 0≤s≤0.2, 0≤t≤0.2, and r+s+t=1, or (E) single crystal LiNiᵣCoₛAlₜO₂ where r≥0.8, 0≤s≤0.2, 0≤t≤0.2, and r+s+t=1.

14. The battery of claim 13, wherein the cathode comprises any one of (B)-(E) where r≥0.8, 0<s≤0.2, 0<t≤0.2, and r+s+t=1.

15. The battery of claim 13, wherein the cathode comprises any one of (B)-(E), the cathode further comprising a dopant, wherein:
the dopant is boron, Mg, Si, Ti, Al, Zn, Fe, Zr, Sn, Sc, V, Cr, Fe, Cu, Ga, Y, N, Mo, Ru, Ta, W, Ir, Ce, or any combination of two or more thereof; and
a molar ratio of the dopant to Li is not greater than 0.05.

16. The battery of claim 13, wherein the cathode further comprises a coating material on at least a portion of an exposed surface of the nickel-containing material, the coating material comprising Al₂O₃, ZrO₂, ZnO, SiO₂, MgO, TiO₂, B₂O₃, AlPO₄, AlF₃, LiNbO₃, or any combination of two or more thereof, wherein a weight percentage of the coating material relative to a weight of the nickel-containing material is not more than 3 wt %.

17. The battery of claim 13, wherein the anode comprises:
lithium metal; or
nanocrystalline silicon; or
microcrystalline silicon; or
silicon oxide (SiO_{q} where 0<q≤2); or
a silicon-metal alloy wherein the metal is Fe, Sn, Ti, Mn, Ni, Cu, or any combination or two or more thereof; or
a silicon-carbon mixture; or
Li₄Ti₅O₁₂ (LTO); or
a carbonaceous material comprising hard carbon, soft carbon, or graphite.

18. The battery of claim 13, wherein the cathode comprises:
a nickel-containing material comprising polycrystalline LiNi_{0.8}Mn_{0.1}Co_{0.1}O₂; or
a nickel-containing material comprising single crystal LiNi_{0.8}Mn_{0.1}Co_{0.1}O₂; or
a nickel-containing material comprising polycrystalline LiNi_{0.9}Mn_{0.05}Co_{0.05}O₂; or
a nickel-containing material comprising single crystal LiNi_{0.9}Mn_{0.05}Co_{0.05}O₂; or
a nickel-containing material comprising single crystal LiNi_{0.9}Mn_{0.05}Co_{0.05}O₂ and a dopant comprising boron.

19. The battery of claim 13, wherein:
the anode comprises graphite; and
the battery has a discharge specific capacity retention of at least 75% after 500 cycles at a charge rate of 0.3 C to 1 C and a discharge rate of 0.3 C to 1 C.

20. The battery of claim 13, further comprising:
(i) a membrane separator between the anode and the cathode; or
(ii) a casing, wherein the casing provides electrically isolated electrical connections to the anode and to the cathode; or
(iii) both (i) and (ii).
